(19) United States
(12) Patent Application Publication
(10) Pub. No.: US 2017/0062952 A1
(43) Pub. Date: Mar. 2, 2017

(54) DUAL BAND, MULTI COLUMN ANTENNA ARRAY FOR WIRELESS NETWORK

(71) Applicant: Ace Antenna Company Inc., Irvine, CA (US)

(72) Inventors: Niranjan Sundararajan, Irvine, CA (US); Charlie Kozak, Mission Viejo, CA (US); Anthony Teillet, Trabuco Canyon, CA (US); Kevin Le, Bel Air, MD (US)

(21) Appl. No.: 14/827,119

(22) Filed: Sep. 2, 2015

(51) Int. Cl. H01Q 21/26; H01Q 19/10; H01Q 9/28

(52) U.S. Cl. CPC H01Q 21/26; H01Q 9/285; H01Q 19/108

(57) ABSTRACT

A dual-band, dual-polarized antenna module for a mobile communication base station, which includes: a reflector plate; a radiation antenna module for transmitting and receiving two linear orthogonal polarizations in first and second frequency band, the radiation antenna module generally having a first set of radiation antenna elements operable in a first frequency band including a plurality of dipoles arranged to form generally rectangular shape, each of the dipoles substantially having a planar shape element with a convex cavity; and a second set of radiation elements operable in a second frequency band which are proximately arranged over a convex cavities in the first set of radiation antenna elements, and includes a plurality of aperture coupled patch elements generally arranged to form a quad-shape.

### FIELD OF THE DISCLOSURE

The present disclosure relates in general to communication systems and components, and is particularly directed to multi column antenna array architecture, containing a plurality of driven radiating elements that are spatially arranged having a quadrature of higher frequency radiating elements positioned within confines of the lower frequency radiating elements while providing an independent operation there between.

### BACKGROUND

A base station antenna for mobile communication is designed by means of a space diversity scheme or a polarization diversity scheme so as to reduce a fading phenomenon. A space diversity scheme means to install a transmitting antenna and a receiving antenna while being spaced a predetermined distance from each other, and has a large limit in space and a disadvantage in cost. Accordingly, a mobile communication system has typically used a dual-band dual-polarized antenna to which a polarized diversity scheme is applied.

Modern wireless antenna array implementation generally includes a plurality of radiating elements that may be arranged over a common reflector plane defining a radiated signal beam-width and elevation plane angle. Multi band antennas are antennas providing wireless signals in multiple radio frequency bands, i.e. two or more frequency bands. They are commonly used and are well known in wireless communication systems, such as GSM, GPRS, EDGE, UMTS, LTE, and WiMax systems. In this respect, the antenna arrays often comprises a plurality of antenna elements adapted for transmitting and/or receiving in different frequency bands. Most often dual band antenna elements are adapted for transmitting and/or receiving in a lower frequency band and in a higher frequency band while the single band antenna elements are adapted for transmitting and/or receiving in the higher frequency band only. The dual band and single band antenna elements are arranged such that the distance between the centers of two adjacent elements transmitting/receiving in the same frequency are often 0.5-1.0 times the wavelength λ for the center frequency for the given operating frequency band, and typically around 0.8λ of that wavelength. That is, the distance between two adjacent single band antenna elements Sx is often 0.8 times the wavelength for the centers frequency for the higher frequency band while the distance between two adjacent dual band antenna elements Qx is often 0.8 times the wavelength for the centers frequency for the lower frequency band.

A prior antenna system antenna assembly has been disclosed in US publication 2013/0002505 by Teillet al. In the published application an antenna assembly comprises a reflector, an array of first frequency band radiating elements configured above the reflector, the elements arranged in one or more columns extending in a first direction, and a plurality of second frequency band radiating elements configured above the reflector including first and second sub groups, each of the first sub group of radiating elements essentially co-located with a corresponding first frequency band radiating element, and wherein the second sub group of radiating elements are configured outside of the first frequency band radiating elements, the second sub group offset with respect to the first sub group of radiating elements in the first direction. Although this type of antenna element array arrangement was adapted and yielded acceptable performance some of the antenna parameters resulted in a limited deployment due to its larger size and weight, which was mandated by spacing between the antenna elements depending on the operating frequency. In prior art arrangement dual band antenna elements required spacing=Vs1+Vs2+Vs1>2λ (where Vs1 and Vs2 dimensions are related to spacing between HAx axis) at a lower frequency band, which limited number of dual frequency band antenna elements that could be placed onto a reflector resulting in a lower forward gain in low frequency band than otherwise is possible. Therefore there is a need to improve compactness of multiband antennas which result in greater forward gain (in both frequency bands), while providing greater number of independent RF terminals per unit volume weight allotted to such multi band antenna array.

### SUMMARY OF THE DISCLOSURE

This disclosure provides an antenna array arrangement which fully or in part mitigates and/or solves the drawbacks of prior art antenna array arrangements. More specifically, the present disclosure provides an antenna array arrangement which makes it possible to support dual band elements where the operating frequency range between lower (FL) and higher (FH) frequency bands is between 1.8 to 3.4 times higher than the lower frequency band.

This disclosure also provides an antenna array arrangement which has a smaller, lighter, and smaller wind load than prior art solutions. This disclosure also provides an alternative antenna array arrangement compared to prior art, by providing higher forward gain in multiple bands while maintaining the same overall volume and weight allotted to antenna array.

According to one aspect of the disclosure, these features are achieved with an antenna array arrangement for a multi band antenna, comprising a plurality of first dual band antenna elements adapted for transmitting/receiving in a lower antenna frequency band and in a higher antenna frequency band, a plurality of first single band antenna elements adapted for transmitting/receiving in the higher antenna frequency band, the first dual band antenna elements and the first single band antenna elements being arranged in a row, wherein at least two first single band antenna elements are arranged adjacent to each other.

Further features and advantages of the present disclosure will be appreciated from the following detailed description of the disclosure. It is an object of the present disclosure to provide a dual band, multicolumn antenna employing interdigitated antenna element technology to achieve broad frequency coverage. In carrying out these and other objectives, features, and advantages of the present disclosure, interdigitated antenna module based antenna array is provided for a wireless network system.

### BRIEF DESCRIPTION OF THE DRAWINGS

FIG. 1 is front view of a vertically positioned multi column antenna array;

FIG. 2 is a prior art front view of a vertically positioned multi column antenna array;

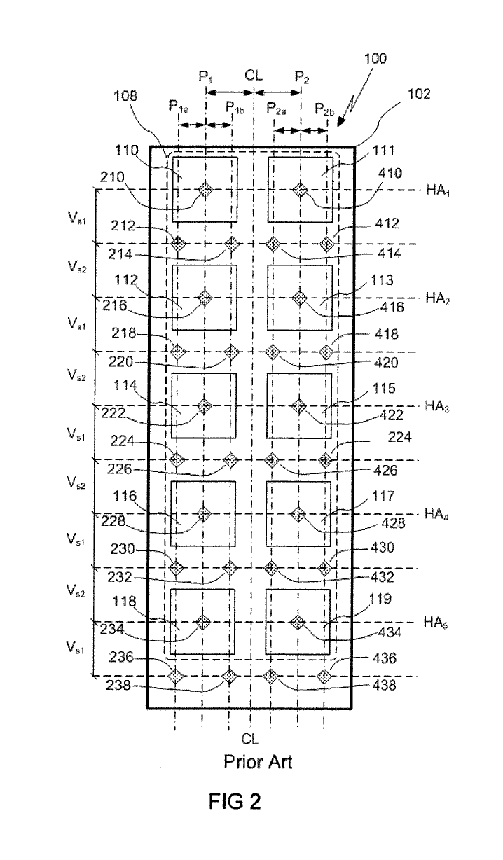

FIG. 3 is an isometric and cross section views of multi band antenna element module;

FIG. 4 is a partial isometric view of multi band antenna element module detailing low frequency (FL) dipole element construction;

FIG. 5 is an isometric view of a vertical support member used to feed low band and high band portions of a multi band antenna element;

FIG. 6 provides integration details of a vertical support member used to feed low band and high band portions of a multi band antenna element;

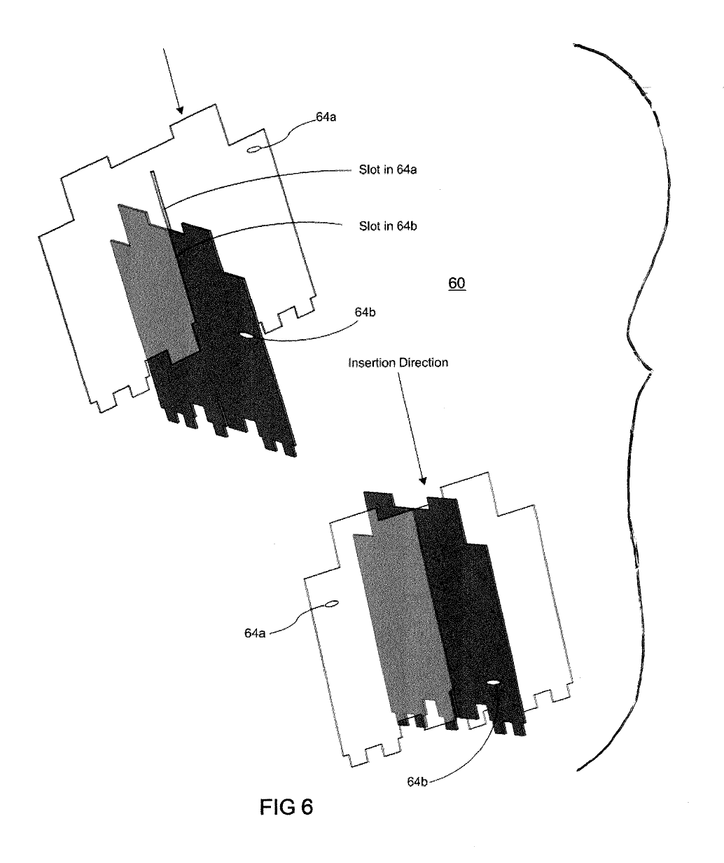

FIG. 7 is a top view of an antenna element distribution network used to feed high (FH) band aperture coupled patch (ACP) elements;

FIG. 8 is top view of one fourth of a high band antenna element detailing feed network;

FIG. 9 is a one half of RF signal distribution network schematic used with 12 port antenna system;

FIG. 10 is top view of alternative high band antenna element detailing unitary aperture feed substrate;

FIG. 11 is an isometric view the antenna module element detailing placement of the parasitic radiators; and

FIG. 12 is an isometric view the antenna module with an alternative embodiment for high band (FH) radiating elements utilizing quad dipole pairs.

### DETAILED DESCRIPTION

Reference is made to the accompanying drawings, which assist in illustrating the various pertinent features of the present disclosure. Due to multi positioning and use of identical elements in the parallel paths these may be referred to without the suffix a or b, and etc. since suffix indicates either of the relevant pair or grouping of elements is being referred to without distinction. The present disclosure will now be described primarily in solving aforementioned problems relating to use of interposed dual band capable antenna elements, and it should be expressly understood that the present disclosure may be applicable in other applications wherein multiband operation of an antenna array is required or desired. In this regard, the following description of a multi band, dual column, cross-polarized antenna array is presented for purposes of illustration and description. Furthermore, the description is not intended to limit the disclosure to the form disclosed herein. Accordingly, variants and modifications consistent with the following teachings, and skill and knowledge of the relevant art, are within the scope of the present disclosure. The embodiments described herein are further intended to explain modes known for practicing the disclosure disclosed herewith and to enable others skilled in the art to utilize the disclosure in equivalent, or alternative embodiments and with various modifications considered necessary by the particular application(s) or use(s) of the present disclosure. Present antenna is suitable for receiving and transmission of Radio Frequency (RF) signals as it shall be understood that signal flow is complementary and bidirectional unless pointed out otherwise.

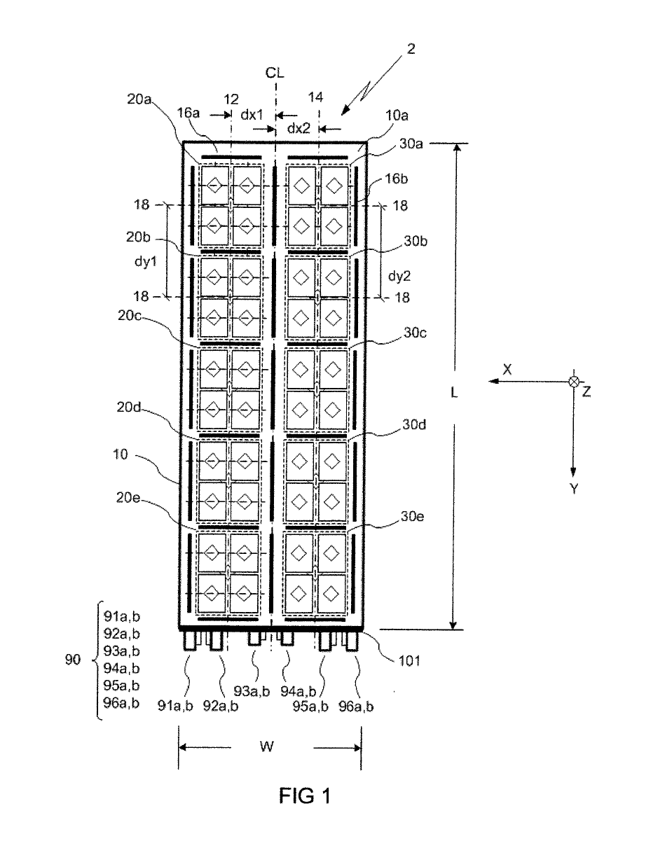

The present disclosure advantageously provides interdigitated antenna elements to achieve multi band operation in an antenna array for receiving and transmitting. With reference to FIG. 1 a first preferred embodiment of an antenna array (2) having two column vertically oriented symmetry (12, 14) axis, each column having five composite antenna modules (20A to 20E, 30A to 30E) positioned longitudinally along respective column (12, 14) axis on the outwardly facing surface (10a) of a common antenna reflector (10) will now be described. It shall be understood that number of composite antenna modules (20A to 20E, 30A to 30E) can be altered to suit specific application requirements without departing from the scope of the present disclosure. A common reflector panel (10) having an outwardly facing (front) surface (10a) and a back surface (10b) may be constructed using a conductive material such as an aluminum alloy having width dimension W (along x axis) and length dimension L (along y axis). Alternative materials and technics can be used without departing from the scope of the present disclosure. Each composite antenna module (20A-20E, 30A-30E) is surrounded by periphery vertical and horizontal portions fences (16A-16B) electrically and mechanically attached to the outwardly facing surface (10a) of the antenna reflector (10) and used to improve low frequency element cross isolation, but it should be noted that other reflector features, such as perimeter edge corrugations, pass through openings, and structural reinforcement elements can be added as necessary, are not shown in the FIG. 1. In the first preferred embodiment the RF distribution networks (40 to 50) used to route RF signals to and from individual composite antenna modules (20A-20E, 30A-30E) are placed on the back side (10b) of the common antenna reflector (10). Antenna feed networks (40 to 50) will be described in detail later. Each column (12, 14) is spaced apart from reflector (10) center line axis CL by distance dx1 and dx2 (along X-axis) to each side from the common reflector center line CL. In the first preferred embodiment distances dx1 and dx2 are the same, but each dimension may be altered to achieve alternative beam width configurations or applications. Distance dx1+dx2 defines separation distance between centers of the composite antenna modules (20A, 30A) along x-axis. Typically this longitudinal separation distance is 0.6λ≦(dx1+dx2)≦0.9λ where λ is a wavelength at center frequency of the low frequency band (FL). Similarly, antenna composite modules (20A-20E, 30A-30E), in corresponding columns (12, 14) are spaced apart by a vertical separation distance, dy1 and dy2 respectively along y-axis. It should be noted that the dy1=dy2 may be altered to suit alternative performance requirements, however in first preferred embodiment equivalent distance between composite antenna modules is used. In general 0.6λ≦(dy1, dy2) 1.2λ where λ is a wavelength at center frequency of the low frequency band (FL). At present cellular systems in the low frequency band (FL) operate in the frequency range between 698-960 MHz whereby LF elements have operating bandwidth greater than 24% and a horizontal beamwidth in the range 50 to 38 deg. In the high frequency band (FH) antenna elements operate in the frequency range between 1710 to 2690 MHz with operating bandwidth greater than 34% and a horizontal beamwidth in the range 37 to 47 deg. Elevation beamwidths of the two orthogonal polarizations are in the range of 29 degrees to 37 degrees and 10 degrees to 15 degrees for the low band and high frequency bands respectively. Alternative frequency ranges may be used without departing from the scope of present invention.

In a second preferred embodiment of an antenna array (2) is equipped with only column 12 axis, each column having five composite antenna modules (20A to 20E, 30A to 30E) positioned longitudinally along respective column (12, 14) axis on the outwardly facing surface (10a) of the common antenna reflector (10) will now be described.

RF interface (90) is provided at the bottom gable (101) of the antenna array (2), but its location may be altered to a suitable location as needed. In first preferred embodiment six sets (91 to 96) antenna ports are provided. Each set of RF antenna ports consists of RF port dedicated to +45 degree and −45 degree polarization—in total 12 RF interfaces are provided (91a, b to 96a, b).

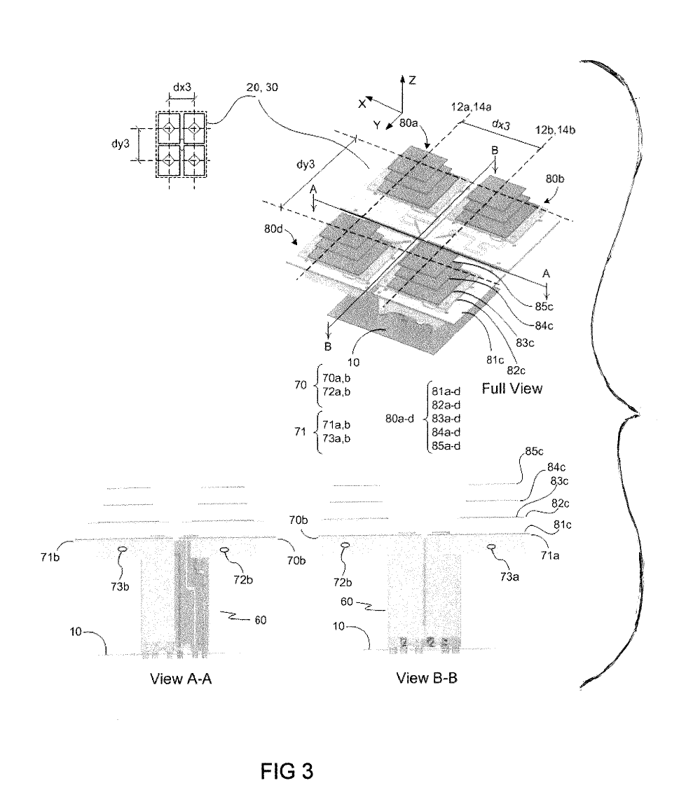

With reference to FIG. 3 dual band composite antenna interdigitated module (20A-20E, 30A-30E) will now be described. Dual band composite antenna module construction can be broken down into three major sub elements:
1) Vertical feed network (60) provides means for routing RF signals to and from respective antenna elements and mechanical support of radiating elements above outwardly facing surface (10a) common antenna reflector (10).
2) A pair (2×) interdigitated planar dipole (70, 71) elements providing cross polarization in the lower frequency band (FL). When planar dipole (70, 71) elements feeds are coupled independently to a transceiver front end such arrangement allows 2×2 MIMO operation in the low band (FL).
3) A quadrature (4×) of high frequency band (FH) microstrip array antenna elements (80a-d) utilizing aperture coupled, cross polarized patch (ACP) antenna elements positioned within perimeter defined by planar dipoles elements (70a-b, 71a-b). When high frequency band (FH) nnicrostrip array antenna elements (80a-d) patch (ACP) antenna elements feeds are coupled independently to a transceiver front end such arrangement allows 4×4 MIMO operation in the high band (FH).

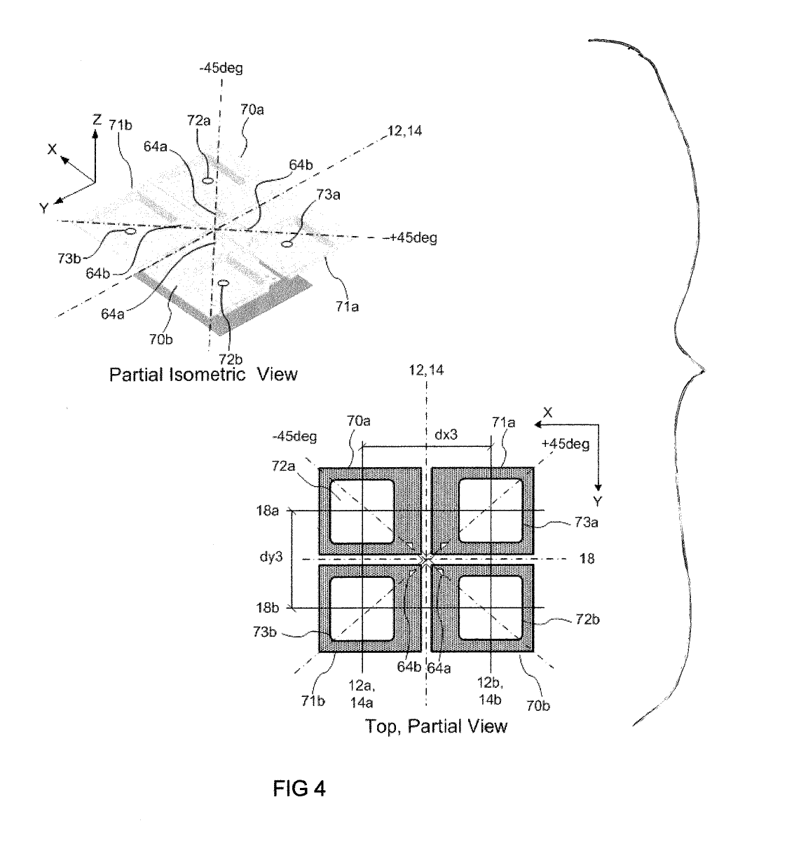

With further reference to FIGS. 3 and 4 dual band composite interdigitated antenna module radiating antenna elements construction details will now be described. In the partial view, FIG. 4, low frequency band (LF) pair (2×) interdigitated planar dipole (70, 71) elements providing cross polarization (−45/+45 deg) electromagnetic signal reception and transmission are provided. Each dipole (70, 71) is constructed using two rectangular planar dipole arms (70a, b; 71a, b). The four planar dipole elements (71a, 70a, 71b, 70b) are preferably arranged to form a four section quadrant in a plane divided by two orthogonal coordinate axes +45 deg and −45 deg whereby intersection of the two axis takes place at a common vertical symmetry axis (12, 14). Overall dimensions for each dipole arm are chosen to provide suitable radiation characteristics in the LF frequency band and may be calculated using modern EM software. The dipole arms (70a, b; 71a, b) are constructed from generally planar conductive material—aluminum for example. However, alternative materials may be used such as an electroplated plastic and the like. First LF dipole (70) utilizes a pair of dipole arms 70a, b oriented −45 degrees to X-axis while second dipole (71) utilizes a pair of dipole arms (71a,b) oriented +45 degrees to the X-axis. Further, each rectangular planar dipole arms (70a, b; 71a, b) is provided with a convex cavity (72a, b; 73a, b) having defined perimeter dimensions and depth. Preferably, cavities have generally cubic volume, but alternative shapes such a circular or elliptical cylindroid, or combination of shapes maybe used to provide needed performance for high frequency FH band element performance. The convex portion of the cavity bottom surface is proximate toward outwardly facing (front) surface (10a) antenna reflector plane 10. The four cavities (71a, b; 72a, b) are utilized to prevent back side radiation from high frequency FH band aperture coupled patch elements which have been omitted from this view. The geometric center of each cavity also defines center point for each FH radiating element (80a-d) and their respective separation distances dx3, dy3. The Y axis centerlines (12a, b; 14a, b) are offset from vertical symmetry axis (12, 14) by a distance dx3/2. Similarly, horizontal X axis centerlines (18a, b) are offset from antenna module horizontal symmetry axis (18) by a distance dy3/2. Further details pertaining to FH band element construction will be described later. The FL band dipole elements (70a, b, 71a, b) provide radiation in the FL band while providing back cavity shield for the FH band elements so as to provide controlled radiation pattern in FH band.

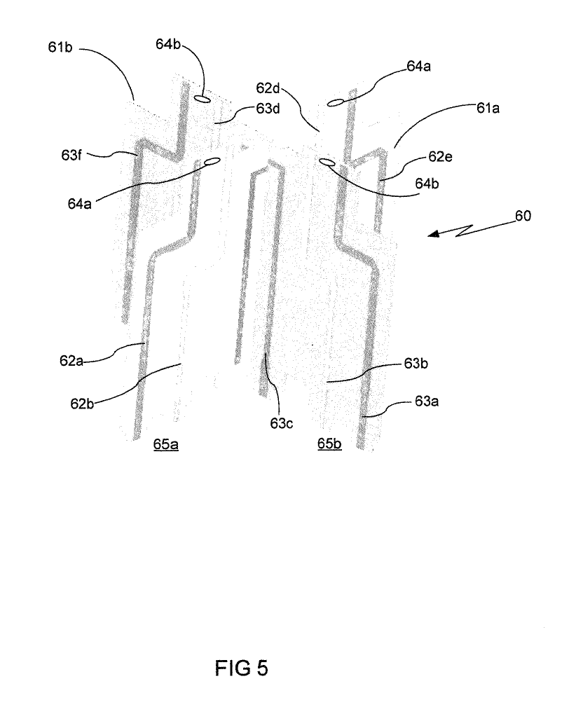

With reference to FIGS. 3, 4 and 5 dual band antenna module (20A-20E, 30A-30E) main feed network (60) will now be described. In first preferred embodiment main feed network (60) comprises of first and second planar structures (61a, b) positioned orthogonally therebetween along length axis. The first and second planar structures (61a, b) can be manufactured from dielectric material (64a, 64b) suitable for forming microstrip substrate. Slots are machined in each dielectric material substrate (64a, b) to allow interlocked X structure to be formed. Each planar structure (61a, b) are used as a microstrip substrate which has a continuous conductor plane side opposite of the microstrip conductor side. The continuous conductor plane provides ground reference to the microstrip lines. Preferably, routing of microstrip lines (62a-e, 63a-e) between antenna elements and RF distribution networks located on the back side of the reflector panel 10. Alternatively, coaxial cables, strip lines and other transmission line techniques can be utilized in place of planar dielectric slabs (61a, b). Table 1 below provides detailed signal routing for each microstrip.

| | | | Function |
|---|---|---|---|
| Slab | Microstrip | Antenna element | (band, polarization) |
| 61a | 62a | 80d | HB +45 |
| 61a | 62b | 80d | HB −45 |
| 61a | 62c | 70b, d | LB +45 |
| 61a | 62d | 80b | HB −45 |
| 61a | 62e | 80b | HB +45 |
| 61b | 63a | 80c | HB +45 |
| 61b | 63b | 80c | HB −45 |
| 61b | 63c | 70a, c | LB −45 |
| 61b | 63d | 80a | HB −45 |
| 61b | 63e | 80a | HB +45 |

A J-Feed network is used to couple to planar dipole elements used for Low frequency band (FL). High band feeds a coupled to aperture coupled patch antenna elements which are used for High frequency band operation (FH). Upper edges (64a, b) protrude through corresponding slots in the dipole arms (70a, b; 71a, b). A composite capacitvely coupled ground connection is provided via top side ground patch (65a-d) in combination with via holes between main feed network (60) first and second planar structures (61a, b) ground planes and interdigitated planar dipoles (70, 71) arms to provide ground reference to the four (80a-d) aperture coupled patch (ACP) antenna elements.

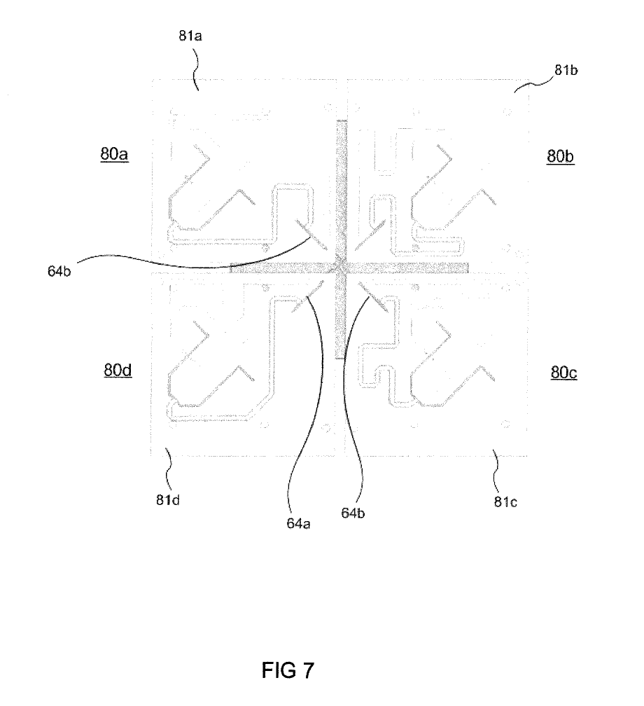

With reference to FIG. 7 the dual band antenna module (20, 30) comprises of four (80a-d) Aperture Coupled Patch (ACP) antenna elements. For the sake of clarity the aperture (83a-d) positioned above aperture feed substrate (81a-d), and director patch elements (84a-d, 85a-d) have been removed to allow direct view of aperture feed substrate (81a-d) positioned below. All four high band (80a-d) ACP's are similarly constructed and subsequent description applies to all four ACP antenna elements. The four (80a-d) aperture coupled patch (ACP) antenna elements are positioned onto outwardly facing surface of each corresponding dipole arms (70a, b; 71a, b). The cavities (72a, b; 73a, b) provide front to back radiation pattern control for the ACP elements. Preferably, aperture feed substrate (81a-d) is co-planarily mounted onto outwardly facing surface of each corresponding dipole arms (70a, b; 71a, b) as it does not adversely affect dipole performance characteristics in the lower frequency band (FL). Furthermore, aperture feed substrate maybe constructed from unitary material (81) in place of four individual substrates (81a-d).

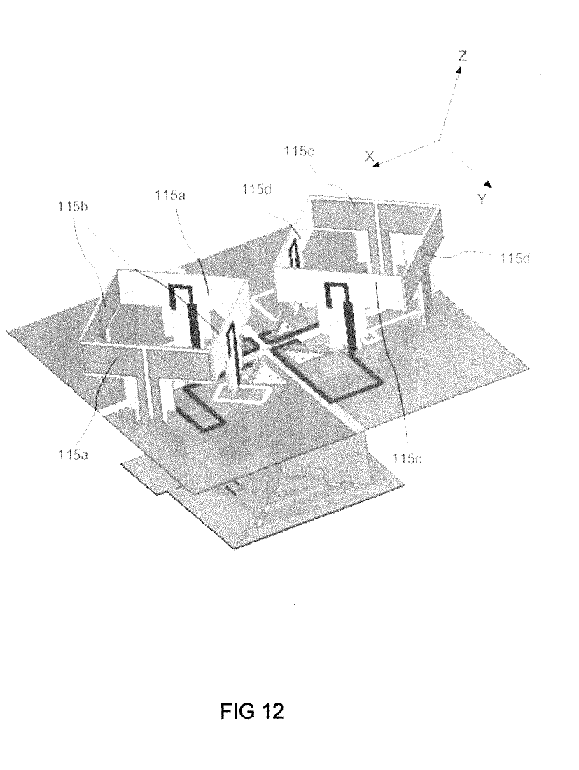

With reference to FIG. 8 details of the aperture feed substrate (81a-d) that couples RF signal for excitation to the +45 deg polarized channel and the −45 deg polarized channels will now be described. The feed line arrangement may comprise of a 50 ohms line (87d, f) and positioned on the outwardly surface of the aperture feed substrate (81a) which divides into two 100 Ohms lines (88d, f; 89d, f). These two lines excite the aperture (83a) constructed on dielectric material (82a-d) and symmetrically positioned above aperture feed substrate (81a). The lines end in open circuit stubs for matching the input impedance to 100 Ohms over the frequency range and a small amount of symmetrical capacitive tuning (88-89t, s; 88q, r) may be applied to both channels. The dual polarization operation is provided by the cross-shaped aperture 83a (not shown in FIGS. 7, 8) with a feed network (88a). This feed arrangement provides the symmetry necessary for high port-to-port (63f, 63d) isolation and good cross polarization over frequency range. Since the feed (88d, f; 89d, f) of both polarization channels are positioned in the same layer it is necessary to have microstrip lines crossing each other at a point such that an air bridge (89j) is constructed. The size and position of the patches are chosen for good performance in lower and upper band of frequency range. To control azimuth beam width additional director patch elements (84a, 85a) positioned in the outwardly direction from the cross-shaped aperture (83a). To provide enhanced cross pole isolation between adjacent modules (20a & b; 20b & c; 30a & b; 30b & c and so on) a plurality of vertically aligned parasitic resonating elements (103a-d) are capacitively coupled the LF dipole along common vertical symmetry axis (12a, b; 14a, b). In present disclosure four parasitic resonating elements may be implemented, however any suitable number may be used. Alternatively, plurality of horizontally positioned parasitic resonating elements (105a-d) may be capacitively coupled and mechanically attached using non-conductive means such as plastic screws or pop rivets to the LF dipole along common horizontal symmetry axis (18a, b) between adjacent column modules (20a, 30a, 20b, 30b and so on). Any combination of any number of both vertically and horizontally aligned parasitic resonating elements (103a-d) and (105a-d) may be implemented to provide cross pole isolation performance.

With reference to FIG. 8 RF feed distribution network—from RF coupling port to radiating antenna elements will now be described. In FIG. 8 details of one half—left side of the antenna are presented. The right side of the antenna is identically constructed and contains its own compliment of low PL2, and high PH3, PH4 band phase and corresponding interconnects.

In the first preferred embodiment antenna is configured for 4×4 MIMO for the high band and 2×2 MIMO for the low band. A total of 12 RF interface ports (91-96a,b) at the lower gable (90) of the antenna are provided. Internally the interface ports (91-96a,b) are coupled to corresponding low band (PL1, PL2) and high band (PH1 to 4) phase shifter—power dividing networks. It is a common practice to utilize fixed phase shifter—power dividing networks (PL1, 2; PH1 to 4) for a fixed beam down tilt or alternatively variable phase shifter networks can provide adjustable beam tilt. Interconnect details are provided in a table below for a left side of antenna, right side is similarly constructed.

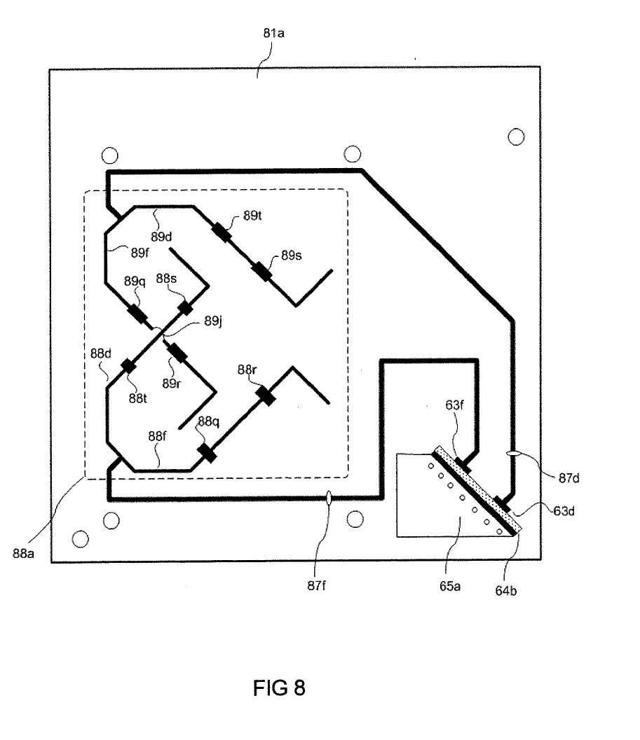

FIG. 9 is a one half of RF signal distribution network schematic used with 12 port antenna system.

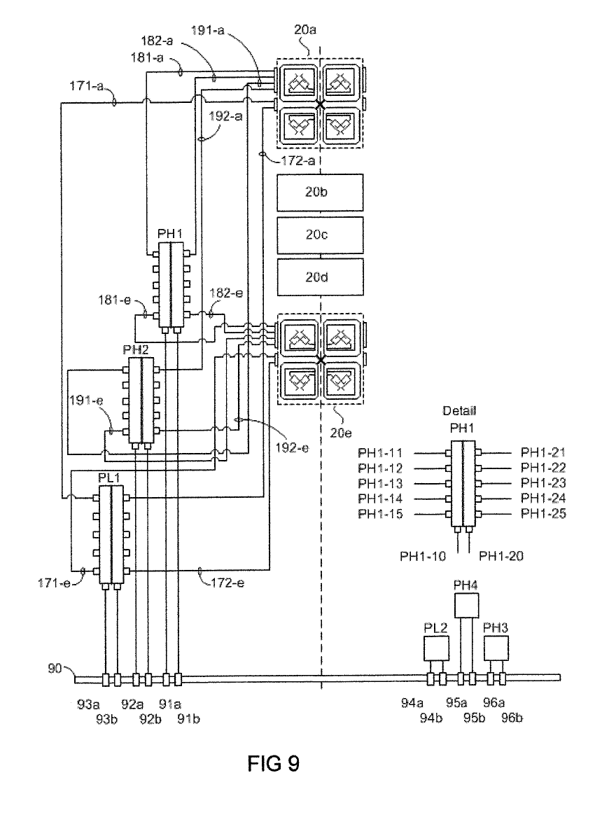

FIG. 10 is top view of alternative high band antenna element detailing unitary aperture feed substrate.

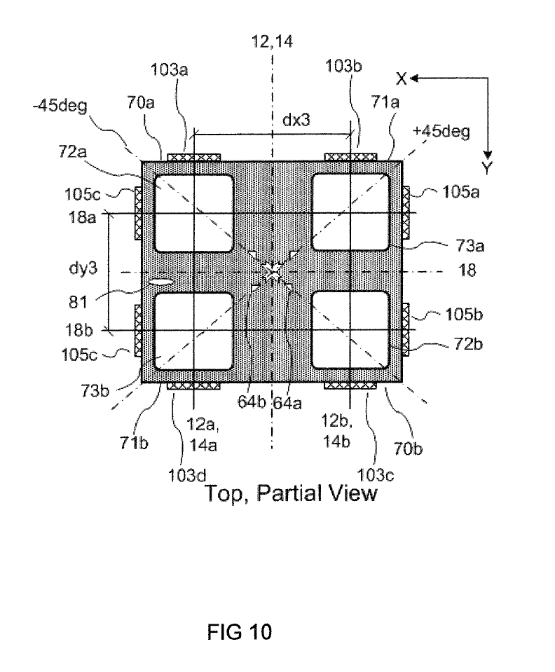

FIG. 11 is an isometric view the antenna module element detailing placement of the parasitic radiators.

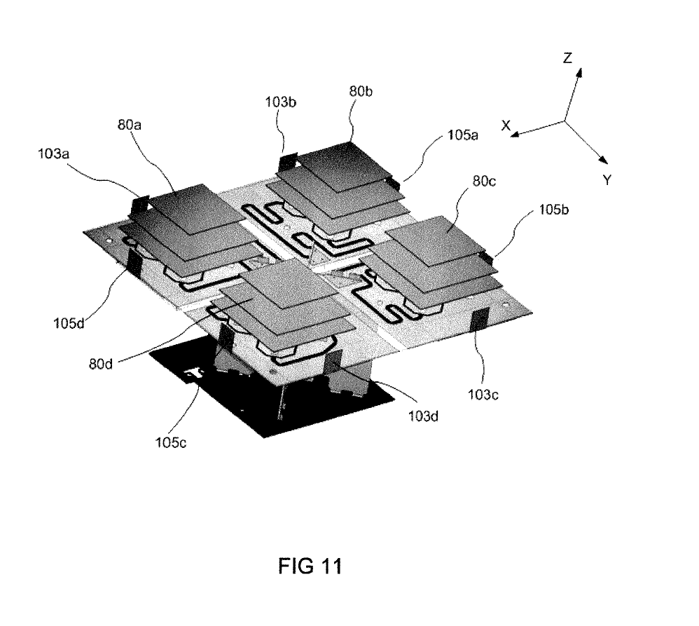

FIG. 12 is an isometric view the antenna module with an alternative embodiment for high band (FH) radiating elements utilizing quad dipole pairs.

| | | Phase | Phase | | | | Element |
|---|---|---|---|---|---|---|---|
| | Input | Shifter | Shifter | Inter- | Ant | Antenna | Feed |
| Band | Port | Common | I/O | connect | Module | Element | Port |
| H1 +45 | 91a | PH1-10 | PH1-11 | 80a-a1 | 20a | 81a | 63f |
| deg | | | | | | 81d | 62a |
| | | | PH1-12 | 80b-a1 | 20b | 81a | 63f |
| | | | | | | 81d | 62a |
| | | | PH1-13 | 80c-a1 | 20c | 81a | 63f |
| | | | | | | 81d | 62a |
| | | | PH1-14 | 80d-a1 | 20d | 81a | 63f |
| | | | | | | 81d | 62a |
| | | | PH1-15 | 80e-a1 | 20e | 81a | 63f |
| | | | | | | 81d | 62a |
| H1 −45 | 91b | PH1-20 | PH1-21 | 80a-a2 | 20a | 81a | 63d |
| deg | | | | | | 81d | 62b |
| | | | PH1-22 | 80b-a2 | 20b | 81a | 63d |
| | | | | | | 81d | 62b |
| | | | PH1-23 | 80c-a2 | 20c | 81a | 63d |
| | | | | | | 81d | 62b |
| | | | PH1-24 | 80d-a2 | 20d | 81a | 63d |
| | | | | | | 81d | 62b |
| | | | PH1-25 | 80e-a2 | 20e | 81a | 63d |
| | | | | | | 81d | 62b |
| H1 +45 | 92a | PH2-10 | PH2-11 | 80a-d1 | 20a | 81b | 63f |
| deg | | | | | | 81c | 62a |
| | | | PH2-12 | 80b-d1 | 20b | 81b | 63f |
| | | | | | | 81c | 62a |
| | | | PH2-13 | 80c-d1 | 20c | 81b | 63f |
| | | | | | | 81c | 62a |
| | | | PH2-14 | 80d-d1 | 20d | 81b | 63f |
| | | | | | | 81c | 62a |
| | | | PH2-15 | 80e-d1 | 20e | 81b | 63f |
| | | | | | | 81c | 62a |
| H1 −45 | 92b | PH2-20 | PH2-21 | 80a-d2 | 20a | 81b | 63b |
| deg | | | | | | 81c | 62d |
| | | | PH2-22 | 80b-d2 | 20b | 81b | 63b |
| | | | | | | 81c | 62d |
| | | | PH2-23 | 80c-d2 | 20c | 81b | 63b |
| | | | | | | 81c | 62d |
| | | | PH2-24 | 80d-d2 | 20d | 81b | 63b |
| | | | | | | 81c | 62d |
| | | | PH2-25 | 80e-d2 | 20e | 81b | 63b |
| | | | | | | 81c | 62d |
| L1 +45 | 93a | PL1-10 | PL1-11 | 70-a1 | 20a | 71 | 62c |
| deg | | | PL1-12 | 70-b1 | 20b | 71 | 62c |
| | | | PL1-13 | 70-c1 | 20c | 71 | 62c |
| | | | PL1-14 | 70-d1 | 20d | 71 | 62c |
| | | | PL1-15 | 70-e1 | 20e | 71 | 62c |
| L1 −45 | 93b | PL1-20 | PL1-21 | 71-a1 | 20a | 70 | 63c |
| deg | | | PL1-22 | 71-b1 | 20b | 70 | 63c |
| | | | PL1-23 | 71-c1 | 20c | 70 | 63c |
| | | | PL1-24 | 71-d1 | 20d | 70 | 63c |
| | | | PL1-25 | 71-e1 | 20e | 70 | 63c |

Alternative configurations are also possible. For example, a 2×2 higher gain MIMO.

What is claimed is:

1. A dual-band dual-polarized antenna module arrangement for receiving and transmitting electromagnetic signals in at least two spaced-apart frequency bands including a first frequency band (FL) and a second frequency band (FH), comprising:
a reflector plate (10);
a first (71a, b) and second (70a, b) set of planar antenna elements spaced apart from the reflector plate, being arranged at +45 and −45 degree axis relative to a symmetry axis (12, 14), respectively, the first and second set of planar antenna elements being operative for transmitting and receiving linear orthogonal polarizations in the first frequency band (FL) and generally forming a four quadrant arrangement; and
a third set of four antenna elements (80a-d) operative for transmitting and receiving two linear orthogonal polarizations in the second frequency band (FH) co-planarily proximate to the first and second set of planar antenna elements, and arranged within a four quadrant arrangement of the first and second planar antenna elements, wherein the first (71a, b) and second (70a, b) set of planar antenna elements and the third set of four antenna elements (80a-d) together produce a predetermined beamwidth in the second frequency band (FH).

2. The dual-band dual-polarized antenna module arrangement for receiving and transmitting electromagnetic signals as claimed in claim 1, wherein the first (71a, b) and second (70a, b) set of planar antenna elements form planar dipoles (70, 71) forming respective feed points at a vertex proximate to an intersection of the +45 degree axis, the −45 degree axis and the symmetry axis (12, 14).

3. The dual-band dual-polarized antenna module arrangement for receiving and transmitting electromagnetic signals as claimed in claim 1, wherein the first (71a, b) and second (70a, b) set of planar antenna elements have a convex cavity (73a, 72a, 73b, 72b), and having a first subset (80a, d) of high-band antenna elements being arranged along a first offset column (12a, 14a) and a first offset row 18a, and a second subset (80b, c) of high-band antenna elements being arranged along a second offset column (12b, 14b) and second offset row 18b, positioned within the four quadrant arrangement of the first and second planar antenna elements (70a, b; 71a, b).

4. The dual-band dual-polarized antenna module arrangement for receiving and transmitting electromagnetic signals as claimed in claim 1, wherein the first (71a, b) and second (70a, b) set of planar antenna elements are adapted for the frequency range of 698 to 960MHz.

5. The dual-band dual-polarized antenna module arrangement for receiving and transmitting electromagnetic signals as claimed in claim 1, wherein the third set of four antenna elements (80a-d) are adapted for the frequency range of 1710 to 2690 MHz.

6. The dual-band dual-polarized antenna module arrangement for receiving and transmitting electromagnetic signals as claimed in claim 1, wherein the first (71a, b) and second (70a, b) set of planar antenna elements are operative in the first frequency band with a bandwidth greater than 24% and a horizontal beamwidth in the range 50 to 38 deg.

7. The dual-band dual-polarized antenna module arrangement for receiving and transmitting electromagnetic signals as claimed in claim 1, wherein the third set of four antenna elements (80a-d) are operative in the second frequency band with a bandwidth greater than 34% and a horizontal beamwidth in the range 37 to 47 deg.

8. The dual-band dual-polarized antenna module arrangement for receiving and transmitting electromagnetic signals as claimed in claim 6, wherein elevation beamwidths of the two orthogonal polarizations of the first and second set of planar antenna elements are in the range of 29 degrees to 37 degrees.

9. The dual-band dual-polarized antenna module arrangement for receiving and transmitting electromagnetic signals as claimed in claim 7, wherein elevation beamwidths of the third set of four antenna elements are in the range of 10 degrees to 15 degrees.

10. The dual-band dual-polarized antenna module arrangement for receiving and transmitting electromagnetic signals as claimed in claim 1, wherein the third set of four antenna elements (80a-d) comprises multiple groups of the four antenna elements, one said group of the four antenna elements being disposed over each quadrant of the first and second planar antenna elements.

11. The dual-band dual-polarized antenna module arrangement for receiving and transmitting electromagnetic signals as claimed in claim 1, wherein the third set of four planar antenna elements comprise a quadrature of microstrip aperture coupled, cross polarized patch antenna elements positioned within a perimeter defined by the first and second set of planar antennal elements.

12. The dual-band dual-polarized antenna module arrangement for receiving and transmitting electromagnetic signals as claimed in claim 11, comprising antenna element feeds coupled between the third set of four planar antenna elements and a transceiver front end configured to provide 4×4 multiple input multiple output (MIMO) operation.
